(19) United States
(12) Patent Application Publication
(10) Pub. No.: US 2025/0171075 A1
(43) Pub. Date: May 29, 2025

(54) METHOD FOR MEASURING THE RACK FORCE ACTING ON A RACK OF A STEERING MECHANISM OF A STEERING SYSTEM FOR A MOTOR VEHICLE, AND STEERING SYSTEM

(71) Applicants: thyssenkrupp Presta AG, Eschen (LI); thyssenkrupp AG, Essen (DE)

(72) Inventors: Riccardo FICCA, Goefis (AT); Wolfram RAITHER, Sevelen (CH)

(73) Assignees: thyssenkrupp Presta AG, Eschen (LI); thyssenkrupp AG, Essen (DE)

(21) Appl. No.: 18/959,211

(22) Filed: Nov. 25, 2024

(30) Foreign Application Priority Data
Nov. 28, 2023 (BE) BE 2023/5962

(51) Int. Cl. B62D 5/04; B62D 3/12

(52) U.S. Cl. CPC B62D 5/0481; B62D 3/12

(57) ABSTRACT

A method for measuring a rack force acting on a rack of a steering mechanism of a steering system for a motor vehicle, in which the rack is movable in a longitudinal direction in the steering mechanism and is coupled to at least one steerable wheel via at least one track rod, comprises measuring the rack force as a reaction force between the steering mechanism and a body part supporting the steering mechanism in the longitudinal direction, thus permitting a simple and robust determination of the rack force.

### CROSS REFERENCE TO RELATED APPLICATION

This application is a U.S. Non-Provisional that claims priority to Belgian Patent Application No. BE 2023/5962, filed Nov. 28, 2023, the entire content of which is incorporated herein by reference.

### FIELD

The present disclosure relates to a method for measuring the rack force acting on a rack of a steering mechanism of a steering system for a motor vehicle, in which the rack is movable in the longitudinal direction in the steering mechanism and is coupled to at least one steerable wheel via at least one track rod.

### BACKGROUND

In a vehicle steering system designed as rack steering, a steering pinion that can be driven in rotation in a steering mechanism engages in linear toothing of a rack, which is mounted in the steering mechanism such that it can be moved in the longitudinal direction given by its longitudinal axis. Driving the steering pinion in rotation, which can be produced manually and assisted by a motor or else purely by a motor, causes a translational displacement of the rack in the longitudinal direction in the steering mechanism, which is fixed to a body part of the vehicle body. The rack is attached via at least one track rod, usually via two track rods, to steering knuckles of wheels to be steered, so that the translational movement of the rack is converted into a steering lock of the wheels.

The steering force applied to produce a steering lock corresponds substantially to the rack load acting on the rack in the longitudinal direction, which, below, is synonymously designated the rack force. This depends on internal and external operating parameters, for example on the steering rate, the friction in the steering mechanism, the roadway conditions and the like.

Driving situations can occur in which the steering lock of a wheel is made more difficult or is blocked, for example by lateral wheel contact with a kerb edge, kerb impact or the like. If a steering action is carried out in such situations, high force peaks can briefly occur, which produce a correspondingly high rack force. In order to avoid excessive wear or overloading, it is known to detect the rack force during driving operation and, if necessary, to adapt the activation of a motor drive of the steering to reduce the loading.

A method for determining the loading of the steering system and the associated rack load is described in DE 10 2019 133 870 A1. It is proposed therein that the steering system can have a force measuring device. This provides for the acting rack force to be determined by means of a rack force estimator while taking a large number of parameters into account, such as, for example, the driver's strength, the power steering motor, frictional and mass inertial force and possibly further relevant influencing variables. The disadvantage with this method is the susceptibility to faults, for example with regard to tolerance-induced deviations, ageing and the like.

Furthermore, in KR 20160092226 A, it has been proposed to incorporate a force measuring cell in a track rod. The disadvantage with this is the complicated structure with a plurality of sensors which, moreover, are installed on moving components. A similar arrangement is described in CN 211308717 U, which has the same disadvantages.

Thus a need exists to permit a simple and robust determination of the rack force.

In some cases, a position of a rack can be adjusted by an electric motor, e.g., by using a belt-drive mechanism, where the rotation of the rotor drives a pulley with a belt. In such cases, the belt can transmit rotary motion to a steering gear, where it is converted into linear movement of the rack.

In connection with such steering systems, a tie-rod can be designed in a way that it deforms in case of an extreme mechanical impact. During deformation, however, the tie-rod might transfer excessive forces towards the steering gear, which could result in damage to the belt or the steering gear itself. The deformed tie-rods can be easily replaced but it is possible that there is no clear indication of the damage to the steering gear and/or the belt. Therefore, a need exists to permit monitoring of the condition of the gear and the belt with special attention to ensure that they comply with required operating conditions and specifications throughout their service life.

US2008271942A1 describes a solution for observing changes in the angular speed of a rotor using a rotational angle sensor (rotor position sensor, RPS). When an impact on the power steering system occurs, the angular speed can exhibit high values due to relative motion between the stator and rotor. However, the solution described therein has shortcomings.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a motor vehicle steering system in a schematic perspective view.

FIG. 2 shows the steering mechanism of the steering system according to FIG. 1 in a schematically partly exploded illustration.

FIG. 3 shows an enlarged detail from FIG. 2.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

In a method for measuring the rack force acting on a rack of a steering mechanism of a steering system for a motor vehicle, in which the rack is movable in the longitudinal direction in the steering mechanism and is coupled to at least one steerable wheel via at least one track rod, the invention provides for the rack force to be measured as a reaction force between the steering mechanism and a body part supporting the steering mechanism in the longitudinal direction.

The method relates to the operation of rack steering. Preferably, the rack can be attached to two steerable wheels of a vehicle axle via two track rods connected to the two ends thereof.

In the method according to the invention, use is made of the fact that the steering force exerted by the steering mechanism to produce a steering lock of the steerable wheels connected thereto reacts on the steering mechanism as a reaction force, wherein external forces, for example during contact with a kerb edge or when travelling over a pothole, coupled back externally from the roadway via the wheels and the track rods, likewise enter into this reaction force. Therefore, the magnitude of this reaction force corresponds relatively realistically and reliably to the rack force actually present on the rack. The reaction force corresponds to the sum of the forces acting between the steering system and the steering mechanism, that is substantially the forces exerted on the interfaces to the steering mechanism via the track rods and the steering shaft. The steering mechanism is attached to a body part of the motor vehicle and supported relative to the reaction force. The body part can be formed with the motor vehicle body or connected directly or indirectly thereto. As a result it is possible to determine the rack force directly from the reaction force present between the steering mechanism and the body part supporting the latter.

One advantage of the method according to the invention is that the measured reaction force can be used uncomplicatedly as a measure of the rack force that is actually present. The reaction force can be detected by measurement as a simple force measurement between the steering mechanism and the body part. No complicated estimation, as in the prior art mentioned at the beginning, is necessary, nor is any complicated and fault-prone attachment of a multiplicity of force sensors to the track rods. As a result, the method according to the invention can be implemented constructionally simply and robustly in measurement terms.

It is possible that the rack can be driven manually and/or by a motor. The linear displacement of the rack in the steering mechanism can be carried out by rotating a steering shaft which has a steering pinion engaging in the rack. As a result, an auxiliary force drive can be implemented in which, in addition to a manual steering torque, a motor-driven auxiliary torque is coupled into the steering shaft. Provision can also be made for a motor-driven auxiliary force for the linear drive of the rack to be introduced directly into the steering mechanism, i.e. not via the steering shaft. Alternatively, the steering mechanism can be formed as a steer-by-wire actuator, in which there is no mechanical connection to a manual steering input and, instead, only an electrically controlled motor linear drive of the rack is implemented.

Provision can preferably be made for the steering mechanism to have a motor drive unit. This is used for the motor-driven production of the rack force and can preferably comprise an electric motor with a rotationally drivable motor shaft, the rotation of which is converted into a linear movement of the rack. For this purpose, a gearbox arrangement known per se can be provided, for example a spindle drive with a rotationally drivable spindle nut and a threaded spindle connected to the rack, or a toothed drive with a rotationally drivable pinion engaging in toothing of the rack. The motor drive unit can preferably be designed to be combined structurally with the steering mechanism, including the motor and the gearbox.

Provision can advantageously be made for the reaction force to be measured by means of at least one electric force sensor. The latter can have strain gauges, piezoelectric elements or the like in a manner known per se. By means of one or more force sensors, the reaction force present between the steering mechanism and the body part can be measured reliably with little outlay. Preferably, one or more force sensors are designed to detect the force in the longitudinal direction in order to measure the rack force acting in the longitudinal direction. Furthermore, one or more force sensors can also be arranged in the transverse direction, i.e. transversely with respect to the longitudinal direction. As a result, transverse forces acting on the rack can also be monitored. As a result, all the rack loads can be detected reliably.

The method can preferably be implemented by the reaction force being measured on a fastening means with which the steering mechanism is connected to the body part. The fastening means is used for the mechanical connection of the steering mechanism to the body part. Accordingly, virtually all the reaction forces are transmitted via one or more fastening means. It is possible with little outlay for a fastening means to be able to have an electric force sensor or itself be designed as such a sensor. It is advantageous that the reaction force is measured on all the fastening means. For this purpose, these can each have at least one force sensor.

One embodiment of the method can be made possible by the steering mechanism being retained elastically displaceably on the body part and a relative displacement between the steering mechanism and the body part generated by the reaction force or dependent thereon being detected. The steering mechanism is connected to the body part via an elastic mounting. This is calibrated in such a way that a defined displacement relative to the body part and correlated unambiguously with the magnitude of the reaction force takes place. This displacement can be detected simply and reliably by measurement and used to determine the reaction force.

In a steering system for a motor vehicle, comprising a steering mechanism in which a rack is movable in the longitudinal direction and is coupled to at least one steerable wheel via at least one track rod, and the steering mechanism has at least one fastening means designed to be connected to a body part, wherein a force measuring device for determining the rack force acting on the rack is provided, the invention provides for at least one fastening means to have a force measuring device.

The steering system according to the invention is designed to implement the method according to the invention described above. All the device features disclosed explicitly or implicitly in connection with the method can expressly be implemented in the steering system.

The force measuring device is designed to detect the reaction force acting between the steering mechanism and the body part, which occurs as a result of the fact that the steering mechanism exerts a steering force on the wheels and is transmitted to the steering mechanism from the wheels.

It is preferred for the force measuring device to have at least one electric force sensor. The force sensor can have a strain gauge, a piezoelectric element or the like. It is preferably connected to the steering mechanism, so that, with respect to the reaction forces acting on the steering mechanism, it is arranged in the force flow between the steering mechanism and the body part. Expressed in another way, the force measuring device is incorporated in between the steering mechanism and the body part. It is possible for a plurality of force sensors to be provided, for example at a plurality of fastening points. At each of the fastening points, a fastening means for connecting the steering mechanism to the body part can be provided, for example a fastening bolt or the like.

By means of one or more force sensors, the reaction force present between the steering mechanism and the body part can be measured reliably with little outlay. Preferably, one or more force sensors for detecting the force in the longitudinal direction can be designed to measure the rack force acting in the longitudinal direction. Furthermore, one or more force sensors can also be arranged in the transverse direction, i.e. transversely with respect to the longitudinal direction. As a result, transverse forces acting on the rack can also be monitored.

Preferably, the steering mechanism can be connected to the body part via at least one fastening means. The mechanical connection of the steering mechanism to the body part is made as a result. Accordingly, virtually all of the reaction forces are transmitted via one or more fastening means. It is possible with little outlay for a fastening means to be able to have an electric force sensor or itself be designed as such a sensor. It is advantageous that all the fastening means each have a force sensor or are operatively connected to such a sensor.

Provision can be made for the steering mechanism to be retained elastically displaceably on the body part and for the force measuring device to be designed to detect a relative displacement between the steering mechanism and the body part. The steering mechanism is connected to the body part via an elastic mounting. It is calibrated in such a way that a defined displacement relative to the body part, unambiguously correlated with the magnitude of the reaction force, takes place, preferably in the longitudinal direction. By means of the force measuring device, a relative displacement between the steering mechanism and the body part, produced by the reaction force or dependent thereon, can be detected, which is unambiguously correlated with the rack force. This displacement can be detected simply and reliably by measurement by using a suitable displacement sensor, for example by means of a strain gauge or the like.

It is possible for a fastening means to have a force sensor. The fastening means itself can be designed as a force sensor, for example as a so-called force measuring bolt or load measuring bolt, or can have an integrated force sensor. Alternatively, a force sensor can be arranged between fastening means interacting for the connection, for example between a fastening bolt and a receiving hole receiving the latter, for example as a force measuring cell, pressure capsule or the like.

One advantageous embodiment can be implemented, for example, by an annular force measuring cell being arranged on a cylindrical bolt, which is preferably supported axially and radially against a corresponding receiving hole on the steering mechanism or the body part. A reliable and easy-to-mount arrangement can be implemented as a result.

It is preferred for the steering mechanism to have a housing, in which the rack is supported and which has fastening means. The fastening means are designed to connect the housing to the body part. They can comprise fastening holes, for example, through which fastening bolts that can be connected to the body part can be led.

It is possible that a manual and/or motor drive is operatively connected to the rack, as described above, in order to implement an auxiliary force drive or a steer-by-wire actuator.

Provision can preferably be made for the steering mechanism to have a motor drive unit. This is used for the motor-driven production of the rack force and can preferably comprise an electric motor with a rotationally drivable motor shaft, the rotation of which is converted into a linear movement of the rack. To this end, a gearbox arrangement known per se can be provided, for example a spindle drive with a rotationally drivable spindle nut and a threaded spindle connected to the rack, or a toothed drive with a rotationally drivable pinion engaging in toothing of the rack. The motor drive unit can preferably be designed to be combined structurally with the steering mechanism, including the motor and the gearbox.

The technologies described herein allow that misuses can be detected by external sensors. In some previous technologies, only non-intentional rotor accelerations could be used to determine such misuse-cases.

In the various figures, the same parts are always provided with the same reference symbols and are therefore as a rule also named or mentioned only once in each case.

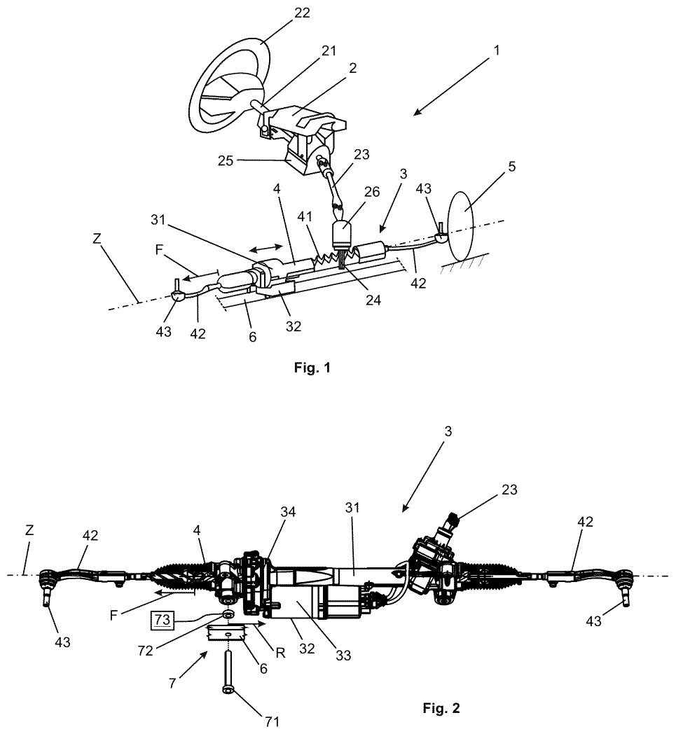

FIG. 1 shows a schematic illustration of a steering system 1 for a motor vehicle which, for example, is designed as an electromechanical power steering system.

The steering system 1 comprises a steering column 2, which can be attached to a body, not shown here, of a motor vehicle. Rotatably mounted in the steering column 2 is a steering spindle 21, to the rear end of which with respect to the direction of travel, facing the driver's position, a steering wheel 22 for the input of manual steering commands is attached.

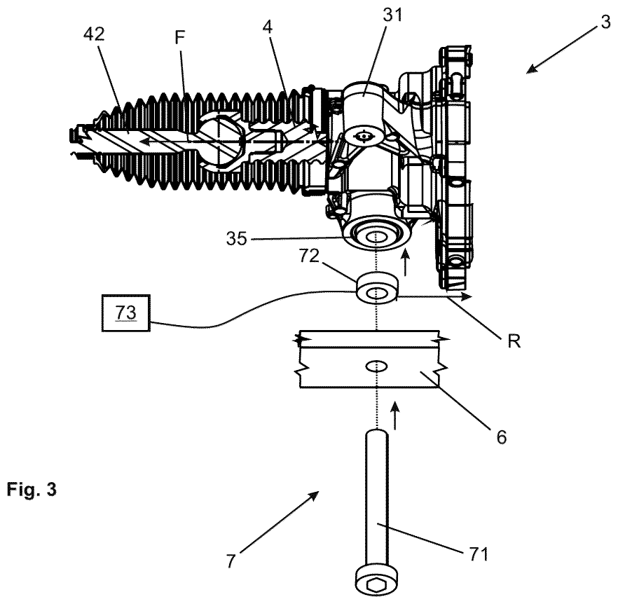

The steering spindle 21 is coupled via a steering shaft 23 to a steering mechanism 3, which is illustrated in detail in FIGS. 2 and 3.

The steering mechanism 3 has a rack 4, which extends in a longitudinal direction Z, which is synonymously also designated a rack direction or adjusting direction.

The rack 4 is supported in a housing 31 of the steering mechanism 3—see FIG. 2—such that it can be displaced in the longitudinal direction Z, as indicated in FIG. 1 by the double arrow. A steering pinion 24 attached to the steering shaft 23 engages in linear toothing 41 of the rack 4.

A rotation of the steering pinion 24 connected to the steering shaft 23 is converted into a linear displacement of the rack 4 in the housing 31 of the steering mechanism 3.

At its two ends, the rack 4 is attached by track rods 42 to steering knuckles 43 of steerable wheels 5. Thus, a displacement of the rack 4 in the longitudinal direction Z causes a steering lock of the wheels 5.

To assist the manual steering with an auxiliary force generated by a motor, an electric drive 25, 26 or 32 can be provided, usually only at one of the three aforementioned positions. The drives 25 and 26 are equipped as auxiliary force drives, by means of which, depending on the driving situation, an auxiliary motor torque assisting the manual steering torque can be coupled into the steering spindle 21 or the steering shaft 23. The overall torque is coupled into the rack 4 via the steering pinion 24.

Alternatively, an electric drive 32 can be attached to the steering mechanism 3. This comprises an electric motor 33 which is able to exert a linear drive force on the rack 4 via a gearbox 34—merely indicated schematically here. For this purpose, for example, a spindle drive or toothed drive can be provided between the motor 33 and the rack 4.

By means of the drive 32, an auxiliary force assisting the manual steering torque can be coupled into the rack 4. Alternatively, it is expressly possible for the rack 4 to be moved exclusively by a motor by the electric drive 32 of the steering mechanism 3 in a steer-by-wire steering system. In this case, no mechanical connection to the steering wheel 22 via the steering shaft 23 is necessary.

The steering mechanism 3 is connected to a body part 6, which is fixed to the motor vehicle body not further illustrated here, for example to a supporting frame or the like.

According to the invention, the steering mechanism 3 is connected to the body part 6 via a fastening means 7. This comprises a fastening bolt 71 and a force sensor 72 which, in the example shown, can have an annular force measuring cell. This is connected to an electric control unit 73, which can detect and evaluate the electrical measured values from the force sensor 72 that correlate with the acting force. On the basis of the measured values thus obtained, one of the drives 25, 26 or 32 can be activated. It is thus possible to detect an overload reliably. It is also conceivable to activate a feedback actuator connected to the steering wheel 22, not illustrated here, which is able to generate a feedback or restoring torque depending on the driving situation.

In the state exploded schematically in the direction of the fastening bolt 71 shown in FIG. 3, the arrows indicate how the fastening bolt 71 can be brought into engagement with the force sensor 72 through an opening in the body part 6. The force sensor can preferably be accommodated and fixed in a form-fitting manner in a receptacle 35 in the housing 31.

When the steering system 1 is actuated to produce a steering lock, a steering force F is applied to the rack 4 manually and by a motor, which is shown schematically in FIGS. 1 to 3. This force is exerted on the track rod 42 by the rack 4, for example directed to the left in the view shown. The steering force F corresponds substantially to the rack force or the rack load acting in the longitudinal direction Z.

The steering mechanism 3 is supported against the body part 6 with a reaction force R of equally high magnitude opposed to the steering force F, as indicated in FIGS. 2 and 3. This reaction force R is transmitted to the force sensor 72 between the housing 31 and the fastening bolt 71. Because of the unambiguous correlation between the reaction force R and the steering force F, which corresponds to the rack force, the rack force can be determined from the electrical measured value from the force sensor 72.

Alternatively, it is also conceivable and possible that the fastening bolt 71 itself has an integrated force sensor, and can be designed as a so-called force measuring bolt or load measuring bolt. In a further alternative, it is possible that the steering mechanism 3 is retained elastically displaceably on the body part 6 and the force measuring device 7 is designed to detect a relative displacement between the steering mechanism 3 and the body part 6, for example by means of a strain gauge or the like.

### List of Reference Symbols

1 Steering system
2 Steering column
21 Steering spindle
22 Steering wheel
23 Steering shaft
24 Steering pinion
25, 26 Drive
3 Steering mechanism
31 Housing
32 Drive
33 Motor
34 Gearbox
35 Receptacle
4 Rack
41 Toothing
42 Track rod
43 Steering knuckle
5 Wheel
6 Body part
7 Fastening means (or fastener)
71 Fastening bolt
72 Force sensor
73 Control unit
Z Longitudinal direction
F Steering force
R Reaction force

1. A method for measuring a rack force acting on a rack of a steering mechanism of a steering system for a motor vehicle, in which the rack is movable in a longitudinal direction in the steering mechanism and is coupled to at least one steerable wheel via at least one track rod, comprising:
measuring the rack force as a reaction force between the steering mechanism and a body part supporting the steering mechanism in the longitudinal direction.

2. The method according to claim 1, wherein the rack is drivable manually and/or by a motor.

3. The method according to claim 1, wherein the steering mechanism has a motor drive unit.

4. The method according to claim 1, wherein the reaction force is measured by at least one electric force sensor.

5. The method according to claim 1, wherein the reaction force is measured on a fastener with which the steering mechanism is connected to the body part.

6. The method according to claim 1, wherein the steering mechanism is retained elastically displaceably on the body part, and a relative displacement between the steering mechanism and the body part, produced by the reaction force, is detected.

7. A steering system for a motor vehicle comprising a steering mechanism, in which a rack is movable in a longitudinal direction and is coupled to at least one steerable wheel via at least one track rod, and the steering mechanism has at least one fastener designed to be connected to a body part, wherein a force measuring device for determining the rack force acting on the rack is provided, wherein at least one fastener has a force measuring device.

8. The steering system according to claim 7, wherein the force measuring device has at least one electric force sensor.

9. The steering system according to claim 7, wherein the steering mechanism is retained elastically displaceably on the body part, and the force measuring device is designed to detect a relative displacement between the steering mechanism and the body part.

10. The steering system according to claim 7, wherein a fastener has a force sensor.

11. The steering system according to claim 7, wherein the steering mechanism has a housing, in which the rack is supported and which has a fastener.

12. The steering system according to claim 7, wherein a manual and/or motor drive is operatively connected to the rack.

13. The steering system according to claim 7, wherein the steering mechanism has a motor drive unit.
